(19) United States
(12) Patent Application Publication
(10) Pub. No.: US 2023/0331899 A1
(43) Pub. Date: Oct. 19, 2023

(54) REACTIVE POLYURETHANE ELASTOMER

(71) Applicant: BASF SE, Ludwigshafen am Rhein (DE)

(72) Inventors: Xiaohui LIU, Grosse lle, MI (US); Herve DIETSCH, Wyandotte, MI (US); Michele Natasha ALLEN, Wyandotte, MI (US); Donald HANDLEN, Wyandotte, MI (US)

(21) Appl. No.: 18/024,300

(22) PCT Filed: Sep. 2, 2021
(86) PCT No.: PCT/US2021/048898

§ 371 Date: Mar. 2, 2023

Related U.S. Application Data
(60) Provisional application No. 63/074,349, filed on Sep. 3, 2020.

(51) Int. Cl. B33Y 80/00; C08G 18/48; B33Y 10/00; B33Y 70/00; B29C 64/129; C08G 18/10

(52) U.S. Cl. CPC C08G 18/4825; B29C 64/129; B33Y 10/00; B33Y 70/00; B33Y 80/00; C08G 18/10; B29K 2075/00

(57) ABSTRACT

Described herein are reactive polyurethane elastomers which may be included in photopolymerizable compositions. Such compositions may be useful in three dimensional printing. Also described are methods of making these polyurethane elastomers. It has been found that the instantly describe elastomers allow for production of 3D printed objects with a unique combination of increased resilience while maintaining requisite strength numbers, making them particularly suitable in a number of industries including shoe soles and medical devices.

### TECHNICAL FIELD

The present disclosure relates to reactive polyurethane elastomers. Such elastomers may be used, for example, in three dimensional (3D) printing technology, and, more specifically, inkjet, stereolithography (SLA), and Digital Light Processing (DLP). The reactive polyurethane elastomers described herein have been shown to exhibit particularly high resilience in combination with sufficient toughness so as to be used in a variety of potential industries where such qualifications are desired.

### BACKGROUND OF THE INVENTION

In the discussion of the background that follows, reference is made to certain structures and/or methods. However, the following references should not be construed as an admission that these structures and/or methods constitute prior art. Applicant expressly reserves the right to demonstrate that such structures and/or methods do not qualify as prior art.

Photocurable compositions are materials used in 3D printing techniques using light source(s) to cure (polymerize) a network of a monomer and oligomer, initiating radical polymerization using a photoinitiator. Generally, these compositions contain photoinitiators, monomers, oligomers, and other components.

There remains a desire to provide oligomers which deliver to the resultant 3D printed article the combination of toughness and resilience needed for particular applications. Currently there are no single component solutions such that a desire exists in the market for improved elastomers.

In addition, the resilience of the ultimately produced elastomer could use improvement. Several industries, including medical device companies, shoe manufacturers, and haptic device manufacturers, have a need for materials which are tough and resilient. It further remains a desire to provide formulations which are able to provide these benefits while limiting the number of components (monomers/oligomers), so as to provide benefit in cost and resource use.

It was surprisingly found that the use of the reactive polyurethane elastomers described herein give a unique combination of significantly improved resilience coupled with sufficient strength/toughness to be used in a variety of applications.

### BRIEF SUMMARY OF THE INVENTION

One aspect of the present technology relates to a reactive polyurethane elastomer which may be used in the formulation of resilient, tough articles capable of being used in a variety of fields. These reactive polyurethane elastomers are composed of a prepolymer (polymer or oligomer) chain and urethane acrylate terminals, as described in more detail below.

In another aspect of the present technology are described methods for formulation of the reactive polyurethane elastomers of the first aspect.

In a first method of formulation, a hydroxyl or amine group terminated prepolymer and a hydroxyl or amine terminated acrylate derivative react with a diisocyanate to form the reactive polyurethane elastomer.

In a second method of formulation, a hydroxyl or amine group terminated prepolymer directly reacts with an isocyanate modified acrylate to produce the reactive polyurethane elastomer. In a third, an acrylate is reacted with an isocyanate modified prepolymer.

In any of these methods of formulation, the reaction may optionally take place in the presence of a catalyst.

In either of these methods of formulation, lean air bubbling under the liquid layer may be used to enhance the final stability of the antioxidants in the product elastomer.

In another aspect of the present technology, the hydroxyl or amine group terminated prepolymer used in any of the methods of formulation, is a polyether diol with weight average molecular weight of up to 10,000 g/mol, for example from 250 to 3000 g/mol, for example from 1,000 to 2,900 g/mol. Optionally, the hydroxyl or amine group terminated prepolymer is a polyether diol with weight average molecular weight of up to 10,000 g/mol, for example from 250 to 3000 g/mol, particularly 2,000 to 2,900 g/mol. In the reactive polyurethane elastomer, the prepolymer chain corresponds to a polyether diol with a weight average molecular weight of up to 10,000 g/mol, for example from 250 to 3000 g/mol, optionally from 2,000 to 2,900 g/mol.

In another aspect of the present technology are compositions containing the herein described reactive polyurethane elastomers. Such compositions may be used, for example, in 3D printing.

In another aspect of the present technology are the compositions above, which further contain one or more additional urethane acrylate oligomers.

In another aspect of the present technology are the compositions of either of the previous two aspects, in which the compositions further contain one or more reactive monomers.

In another aspect of the present technology are methods of producing 3D printed articles by applying successive layers of one or more of the described compositions in any embodiment to fabricate a 3D article; and irradiating the successive layers with UV irradiation. In any embodiments, the composition may be inkjet, SLA, and/or DLP deposited.

In another aspect of the present technology are 3D articles produced by the methods described herein. In any embodiments, the composition may be deposited by inkjet, SLA, or DLP.

In another aspect of the present technology are 3D printed articles as set forth herein, which have a resilience over 20%. Optionally, the 3D printed articles, in addition to a resilience over 20%, have a tear resistance over 30 N/mm, and elongation at break larger than 200%.

### DEFINITIONS

Prior to describing the invention in further detail, the terms used in this application are defined as follows unless otherwise indicated.

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

“Optional” or “optionally” means that the subsequently described circumstance may or may not occur, so that the description includes instances where the circumstance occurs and instances where it does not.

The term “pre-determined” refers to an element whose identity is known prior to its use.

As used herein, the term “Stereolithography” or “SLA” refers to a form of 3D printing technology used for creating models, prototypes, patterns, and production of parts in a layer-by-layer fashion using photopolymerization, a process by which light causes chains of molecules to link, forming polymers. Those polymers then make up the body of a three-dimensional solid.

As used herein, the term “Digital Light Processing” or “DLP” refers to an additive manufacturing process, also known as 3D printing and stereolithography, which takes a design created in a 3D modeling software and uses DLP technology to print a 3D object. DLP is a display device based on optical micro-electro-mechanical technology that uses a digital micromirror device. DLP may be used as a light source in printers to cure resins into solid 3D objects.

### DETAILED DESCRIPTION OF THE INVENTION

Before the present invention is described in greater detail, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

Certain ranges are presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating unrecited number may be a number which, in the context in which it is presented, provides the substantial equivalent of the specifically recited number.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are now described.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

Described herein are a family of high-performance urethane acrylate elastic materials that might be used in molding, coating, or additive manufacturing. The material can be cured by UV, E-beam and other energy curing. Such a reactive polyurethane elastomer may be used, for example, in 3D printing applications in a variety of industries, for example medical devices, shoes, and haptic devices.

These high-performance urethane acrylate materials have a structure which contains a prepolymer (polymer or oligomer) chain and urethane acrylate terminals.

The reactive polyurethane acrylate elastomers described herein generally fall into the following structure:

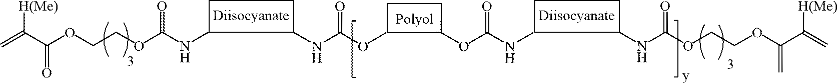

wherein x is in each case 1 to 15, for example 1 to 11, y is 1 to 20, for example 1 to 16, and “H(Me”) indicates the presence of either hydrogen or a methyl group.

There are two separate exemplary routes for achieving these elastomeric materials. In the first, a hydroxyl or amine group terminated prepolymer and a hydroxyl or amine terminated acrylate derivative react with diisocyanate to form the product (Figure 1).

In the second route, hydroxyl or amine group terminated prepolymer directly react with an isocyanate modified acrylate to produce the claimed urethane acrylate.

The hydroxyl or amine group terminated prepolymer may for example be a polyether or a copolymer containing polyether. For example, the hydroxyl or amine group terminated prepolymer may be a copolymer of ethylene and propylene, or a polyether homopolymer.

Optionally, the hydroxyl or amine group terminated prepolymers may be polyester or polyether contained copolymer, such as PolyTHF polyether diols. The molecular weight of such polymers may be between 500 to 100,000 Da, for example 2,000 to 100,000 Da, for example between 2,000 and 2,900 or 2,500 to 2,900 Da.

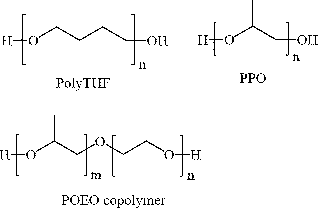

The diisocyanate which may be used is for example, hexamethylenediisocyanate (HDI), isophorone diisocyanate (IPDI), toluene diisocyanate (TDI) (for example as 2,4- isomer, 2,6- isomer, or mixtures thereof), or methylene diphenyl diisocyanate (MDI).

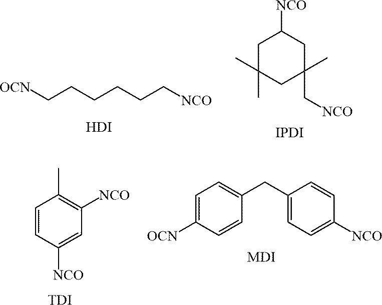

The hydroxyl or amine terminated acrylate derivatives may optionally be 2-hydroxyethyl acrylate, 4-hydroxybutyl acrylate, or 2-hydroxyethyl methacrylate. Exemplary hydroxyl or amine terminated acrylate derivatives may optionally be any of the hydroxyl or amine terminated acrylate derivatives encompassed in the below formula:

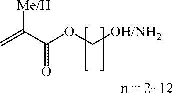

wherein “Me” is methyl.

In the second route of synthesis, an isocyanate modified acrylate is used and reacted directly with the hydroxyl or amine group terminated prepolymer. The hydroxyl or amine group terminated prepolymer would be the same as that given in the first route of synthesis described above. The isocyanate modified acrylate is made, for example, by reacting an acrylate derivative such as described above with a diisocyanate such as described above. Such an isocyanate modified acrylate may be a modified acrylate according to formula (I):

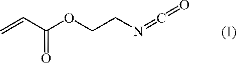

This second route of synthesis is exemplified by the following reaction:

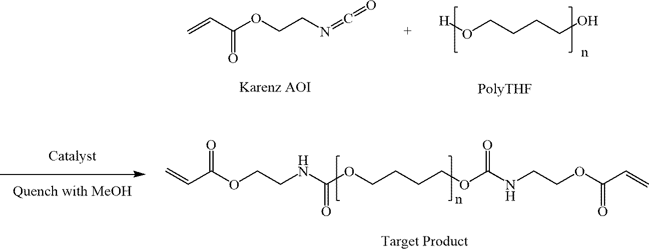

In the above reaction, the molecular ratio of isocyanate modified acrylate (Karenz AOI) to polyol (PolyTHF) can be 2:1. Catalysts which may be used for this process include any catalysts known in the art, including but not limited to zinc catalysts such as zinc neodecanoate, tin catalysts such as bis(2-ethylhexanoate) tin and tin dioctanoate, as well as dibutyltin dilaurate, bismuth 2-ethylhexanoate.

According to either route, the process may be carried out thermally or in the presence of a catalyst. In any embodiments, the process is carried out thermally. For example, the process is carried under thermal conditions suitable for polymerization. In any embodiments, the process is carried out in the presence of a catalyst. For example, suitable catalysts include, but are not limited to, organozinc, tetraalkylammonium, or organotin compounds. In any embodiments, the catalyst is an organozinc compound. For example, suitable organozinc compounds include, but are not limited to, zinc acetylacetonate, zinc 2 ethylcaproate, and the like. In any embodiments, the catalyst is a tetraalkylammonium compound. For example, suitable tetraalkylammonium compounds include, but are not limited to, N,N,N-trimethyl-N-2-hydroxypropylammonium hydroxide, N,N,N-trimethyl-N-2-hydroxypropylammonium 2-ethylhexanoate, and the like. In any embodiments, the catalyst is an organotin compound. For example, suitable organotin compounds include, but are not limited to, dibutyltin dilaurate.

According to any embodiment, the process may be carried out at a temperature of about 25° C. to about 100° C. For example, suitable temperatures include, but are not limited to, about 25° C. to about 100° C., about 25° C. to about 75° C., about 25° C. to about 50° C., or about 50° C. to about 100° C.

The reactive polyurethane acrylate elastomers produced via these routes of synthesis would generally fall into the following structure, where the definitions are as given above:

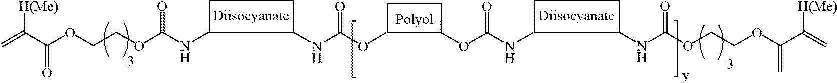

Some exemplary polyurethane acrylate elastomers useful according to the instantly described invention are set forth below:

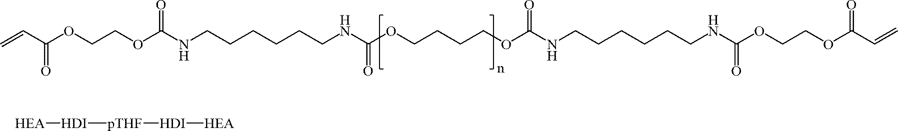

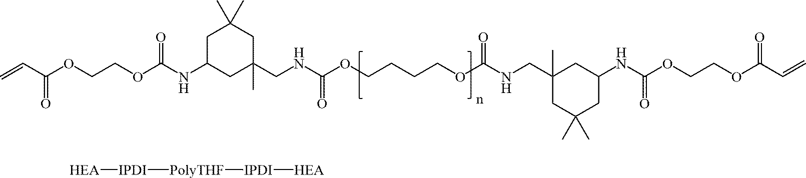

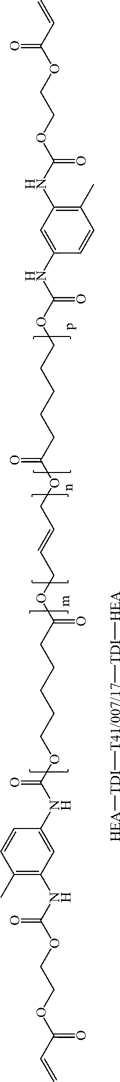

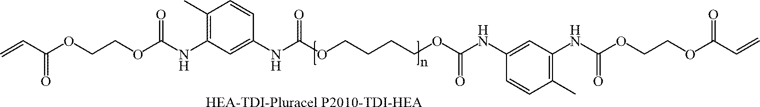

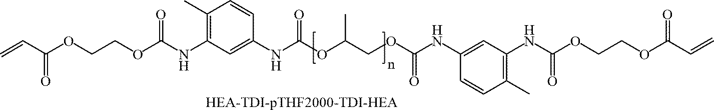

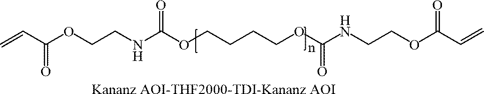

In each of the above, n is a number from 1 to 20, for example 1 to 11, and varies depending on the molecular weight of the polyol being used. The values for m and p are optionally from 0 to 16, for example 1 to 16.

It is a benefit of the reactive polyurethane elastomers described herein that they have a particular combination of resilience and toughness that render them particularly useful for a variety of applications, such as in shoe soles and medical devices. Three dimensionally printed articles from these elastomers have, for example, a resilience over 20%. Optionally, the 3D printed articles, in addition to a resilience over 20%, have a tear resistance over 30 N/mm, and elongation at break larger than 200%.

In addition to the above elastomers and methods for fabrication of elastomers, also described herein are compositions containing the elastomers. These compositions may, for example, be useful in creating 3D printed articles.

Also described herein is a composition for use in three dimensional printing by way of photopolymerization which contains the elastomers described herein.

The compositions may include one or more ethylenically unsaturated monomers. The one or more ethylenically unsaturated monomers may include a vinyl and/or (meth)acrylate monomer. Suitable ethylenically unsaturated monomers include, but are not limited to, (meth)acrylate monomers, (meth)acrylamide monomers, vinyl monomers, and combinations thereof. For example, suitable (meth)acrylate and (meth)acrylamide monomers include, but are not limited to, isobornyl (meth)acrylate, phenoxyethyl (meth)acrylate, tert-butyl cyclohexyl (meth)acrylate, hexanediol di(meth)acrylate, trimethylolpropane formal (meth)acrylate, polyethylene glycol di(meth)acrylate, isodecyl (meth)acrylate, hexyl (meth)acrylate, cyclohexyl (meth)acrylate, 2-ethylhexyl(meth) acrylate, octyl (meth)acrylate, nonyl (meth)acrylate, stearyl (meth)acrylate, 2-phenoxy (meth)acrylate, 2-methoxyethyl (meth)acrylate, lactone modified esters of acrylic acid, lactone modified esters of methacrylic acid, methacrylamide, methyl (meth)acrylate, butyl (meth)acrylate, isobutyl (meth)acrylate, allyl (meth)acrylate, tetrahydrofuryl (meth)acrylate, n-hexyl (meth)acrylate, 2-(2-ethoxyethoxy)ethyl (meth)acrylate, n-lauryl (meth)acrylate, 2-phenoxyethyl (meth)acrylate, glycidyl (meth)acrylate, glycidyl (meth)acrylate, (meth)acrylated methylolmelamine, 2-(N,N- diethylamino)-ethyl (meth)acrylate, neopentyl glycol di(meth)acrylate, alkoxylated neopentyl glycol di(meth)acrylate, ethylene glycol di(meth)acrylate, hexylene glycol di(meth)acrylate, diethylene glycol di(meth)acrylate, tripropylene glycol di(meth)acrylate, tetraethylene glycol di(meth)acrylate, pentaerythritol di(meth)acrylate, pentaerythritol tri(meth)acrylate, pentaerythritol tetra(meth)acrylate, pentaerythritol penta(meth)acrylate, trimethylolpropane tri(meth)acrylate, phenoxyethyl (meth)acrylate, hexanediol di(meth)acrylate, 4-tert-butyl cyclohexyl (meth)acrylate, alkoxylated trimethylolpropane tri(meth)acrylate which contains from 2 to 14 moles of either ethylene or propylene oxide, tri ethylene glycol di(meth)acrylate, tetraethylene glycol di(meth)acrylate, butyl-allyl-ether isobornyl (meth)acrylate, polyethylene glycol di(meth)acrylate, and 4-acryloyl morpholine.

Suitable vinyl monomers include, but are not limited to, N-vinylformamide (NVF), adducts of NVF having diisocyanates such as toluene diisocyanate and isophorone diisocyanate (IPDI), derivatives of N-vinylformamide, N-vinylcaprolactam, N-vinylpyrrolidone, butyl-vinylether, 1,4-butyl-divinylether, dipropyleneglycol-divinylether, triallylisocyanurate, diallylphthalate, and vinyl esters of acetic acid, lauryl acid, dodecanoic acid, cyclohexylcarboxylic acid, adipic acid, glutaric acid and the like.

The compositions may include one or more photoinitiators. Suitable photoinitiators include, but are not limited to, bis(2,4,6-trimethylbenzoyl)-phenylphosphine oxide, 2,4,6-trimethylbenzoylphenyl phosphinate, bis(2,6-dimethoxybenzoyl)-2,4,4-trimethylpentylphosphine oxide, diphenyl(2,4,6-trimethylbenzoyl)phosphine oxide, alpha-hydroxy cyclohexyl phenyl ketone, 2-hydroxy-1-(4-(4-(2-hydroxy-2-methylpropionyl)benzyl)phenyl-2-methylpropan-1-one, 2-hydroxy-2-methyl-1-phenylpropanone, 2-hydroxy-2-methyl-1-(4-isopropylphenyl)propanone, oligo (2-hydroxy-2-methyl- 1 -(4-( 1 -methylvinyl)phenyl)propanone, 2-hydroxy-2-methyl- 1 -(4-dodecylphenyl)propanone, 2-hydroxy-2-methyl-1-[(2-hydroxyethoxy)phenyl]propanone, benzophenone, substituted benzophenones, and mixtures of any two or more thereof.

Where the compositions described herein contain ethylenically unsaturated monomers, the relative amount of the monomers and the instantly described reactive polyurethane oligomer are controlled, so that the reactive monomer is present in an amount of 0.5 to 99.5%, optionally 20 to 80% by weight based on the total amount of reactive monomer and reactive polyurethane oligomer. Optionally, the composition may include 10 to 90, 20 to 80, 25 to 75, 30 to 70, or 40 to 60% by weight of reactive monomer, based on the combination of reactive monomer and reactive polyurethane oligomer.

The compositions described herein may include, in addition to the instantly described reactive polyurethane elastomers, one or more urethane acrylate oligomers. Urethane acrylate oligomers include, for example, commercially available urethane-acrylate oligomers. Exemplary urethane acrylates of this type are derived from the group consisting of polyether, polyester, polycarbonate, alkyl or aryl polyols, alkyl or aryl polyisocyanates, hydroxyl functional (meth)acrylates, and blends of polyols and/or isocyanates.

The compositions described herein may include one or more photoinitiators. Suitable photoinitiators include, but are not limited to, bis(2,4,6-trimethylbenzoyl)-phenylphosphine oxide, 2,4,6-trimethylbenzoylphenyl phosphinate, bis(2,6-dimethoxybenzoyl)-2,4,4-trimethylpentylphosphine oxide, diphenyl(2,4,6-trimethylbenzoyl)phosphine oxide, alpha-hydroxy cyclohexyl phenyl ketone, 2-hydroxy-1-(4-(4-(2-hydroxy-2-methylpropionyl)benzyl)phenyl-2-methylpropan-1-one, 2-hydroxy-2-methyl-1-phenylpropanone, 2-hydroxy-2-methyl-1-(4-isopropylphenyl)propanone, oligo (2-hydroxy-2- m ethyl- 1 -(4-( 1 -methylvinyl)phenyl)propanone, 2-hydroxy-2-methyl- 1 -(4-dodecylphenyl)propanone, 2-hydroxy-2-methyl-1-[(2-hydroxyethoxy)phenyl]propanone, benzophenone, substituted benzophenones, and mixtures of any two or more thereof. In any embodiments, the one or more photoinitiators may be diphenyl(2,4,6-trimethylbenzoyl)phosphine oxide, ethyl(2,4,6-trimethylbenzoyl)phenylphosphinate, 1-hydroxycyclohexylphenylketone, and combinations of two or more thereof.

In any embodiments, the one or more photoinitiators may be present in an amount of about 0.01 wt.% to about 6.0 wt.% of the total weight of the composition. Suitable amounts of the photoinitiator include, but are not limited to, about 0.01 wt.% to about 6.0 wt.%, about 0.1 wt.% to about 4.0 wt.%, about 0.20 wt.% to about 3.0 wt.%, or about 0.5 wt.% to about 1.0 wt.%, or about 1 to 2 wt%, based on the photopolymerizable composition. In one embodiment, the photoinitiator is present in an amount from 0.25 wt.% to about 2.0 wt.%. In another embodiment, the photoinitiator is present in an amount from 0.5 wt.% to about 1.0 wt.%.

According to any embodiments, the compositions may further include a solvent. Suitable solvents include, but are not limited to, propylene glycol monomethyl ether acetate, tripropylene glycol methyl ether, tripropylene glycol n-butyl ether, propylene glycol methyl ether, propylene glycol phenyl ether, propylene glycol n-butyl ether, propylene glycol diacetate, dipropylene glycol methyl ether, dipropylene glycol n-propyl ether, dipropylene glycol n-butyl ether, dipropylene glycol dimethyl ether, and mixtures of two or more thereof.

According to any embodiments, the compositions may further include nanoparticles. Suitable nanoparticles include, but are not limited to, organocation-modified phyllosilicates, TiO₂, ZnO, Ag, SiO₂, Fe₃O₄, CaCO₃, Al₂O₃, Mg(OH)₂, Al(OH)₃, CeO₂, MnO₂, cellulose, graphene, carbon fiber, carbon nanotube, clays such as cloisite, montmorillonite, hectorite, saponite, or the like and mixtures of two or more thereof. In any embodiments, the nanoparticle may be an organocation-modified phyllosilicate. In any embodiments, the organocation-modified phyllosilicate is alkylammonium cation exchanged montmorillonite.

According to any embodiments, the compositions may further include performance modifiers. Suitable performance modifiers include, but are not limited to, thiols, silyl acrylates, and thiol-functional silanes. In any embodiments, the performance modifier is a thiol. For example, suitable thiols include, but are not limited to, 1-pentanethiol, 1-hexanethiol, 1-heptanethiol, 1-octanethiol, 1-decanethiol, 1-dodecanethiol, 1-hexadecanethiol, 1-octadecanethiol, cyclohexanethiol, eicosanethiol, docosanethiol, tetracosanethiol, hexacosanethiol, octacosanethiol, t-dodecyl mercaptan, methyl thioglycolate, methyl-3-mercaptopropionate, ethyl thioglycolate, butyl thioglycolate, butyl-3- mercaptopropionate, isooctyl thioglycolate, isooctyl-3-mercaptopropionate, isodecyl thioglycolate, isodecyl-3-mercaptopropionate, dodecyl thioglycolate, dodecyl-3- mercaptopropionate, octadecyl thioglycolate, octadecyl-3-mercaptopropionate, thioglycolic acid, 3-mercaptopropionic acid, and mixtures of two or more thereof.

In any embodiments, the performance modifier may be a thio-functional silane. For example, suitable thio-functional silanes include, but are not limited, bis(3-triethoxysilylpropyl)-tetrasulfide, gamma-mercaptopropyltimethoxysilane, gamma-mercaptopropyl-triethoxysilane, and mixtures of two or more thereof.

According to any embodiments, the composition may further include ethylenically functional or non-functional non-urethane oligomers, which may further enhance the mechanical and chemical properties of the composition of the present technology. Suitable non-urethane oligomers include, but are not limited to, epoxy, ethoxylated or propoxylated epoxy resins, polyesters, polyethers, polyketones, and mixtures of two or more thereof.

Applying the composition to obtain the three-dimensional article may include depositing the composition. In any embodiments, the application may include depositing a first layer of the composition and second layer of the composition to the first layer and successive layers thereafter to obtain a 3D article. Such depositing may include one or more methods, including but not limited to, UV inkjet printing, SLA, continuous liquid interface production (CLIP), and DLP. Other applications for the compositions include, but are not limited to, other coating and ink applications for printing, packaging, automotive, furniture, optical fiber, and electronics.

The methods described herein include contacting the layers of the composition with ultraviolet light irradiation to induce curing of the composition. In any embodiments, the contacting includes short wavelength and long wavelength ultraviolet light irradiation. Suitable short wavelength ultraviolet light irradiation includes UV-C or UV-B irradiation. In one embodiment, the short wavelength ultraviolet light irradiation is UV-C light. Suitable longwave ultraviolet light irradiation includes UV-A irradiation. Additionally, Electron Beam (EB) irradiation may be utilized to induce curing of the composition.

The methods described herein include repeating the deposition of layers of the composition and exposure to UV irradiation to obtain the 3D article. In any embodiments, the repeating may occur sequentially wherein depositing the layers of composition is repeated to obtain the 3D article prior to exposure to UV irradiation. In any embodiments, the repeating may occur subsequently wherein the deposing the layers of composition and exposure to UV irradiation are repeated after both steps.

In another related aspect, a 3D article is provided that includes UV cured successive layers of the any of the compositions as described herein. In any embodiments, the composition may have been inkjet, SLA, or DLP deposited.

In any embodiments, the 3D article may include a polishing pad. In any embodiments, polishing pad is a chemical mechanical polishing (CMP) pad. Polishing pads may be made following any known methods, for example the methods provided in U.S. Pat. Appl. No. 2016/0107381, U.S. Pat. Appl. No. 2016/0101500, and U.S. Pat. No. 10,029,405 (each incorporated herein by reference).

The 3D article of the present technology exhibits improved toughness. In any embodiments, the three-dimensional article may, for example, exhibit a tensile strength of 56 to 75 MPa, or optionally 26 to 55 MPa. The three-dimensional article may optionally have an impact strength of 15 to 80 J/m or optionally 13 to 54 J/m.

### Exemplary Embodiments

In a first embodiment is described a reactive polyurethane elastomer according to formula (I):

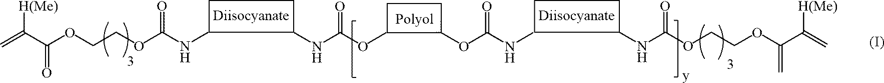

wherein H(Me) indicates either a hydrogen or methyl group,
each x independently is a number in the range of from 1 to 11,
y is a number in the range of from 1 to 20,
Diisocyanate is selected from the group consisting of TDI, HDI, IPDI, and isocyanate-functional acrylate;
Polyol is a polyether or polyerster polyol.

In a second embodiment is described the reactive polyurethane elastomer according to the first embodiment, wherein the diisocyanate is selected from the group consisting of hexamethylene diisocyanate, isophorone diisocyanate, toluene diisocyanate, and methylene diphenyl diisocyanate.

In a third embodiment is described the reactive polyurethane elastomer according to the second embodiment, wherein the diisocyanate is hexamethylene diisocyanate or isophorone diisocyanate.

In a fourth embodiment is described the reactive polyurethane elastomer according to any one of the first three embodiments, wherein the polyol is a polyether diol with a molecular weight in the range of from 500 to 5,000.

In a fifth embodiment is described the reactive polyurethane elastomer according to the fourth embodiment, wherein the polyether diol has a molecular weight in the range of 2,000 to 2,900.

In a sixth embodiment is described the reactive polyurethane elastomer according to the first embodiment, wherein the reactive polyurethane elastomer is selected from the group consisting of

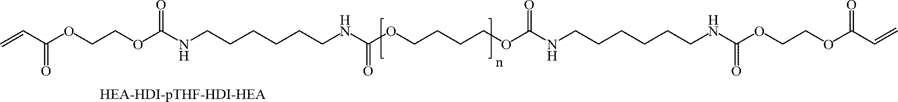

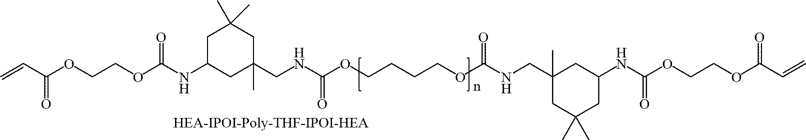

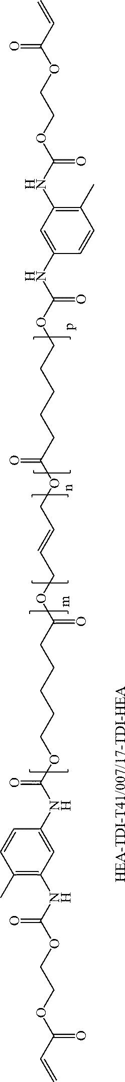

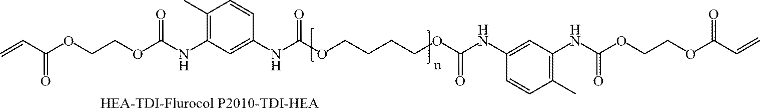

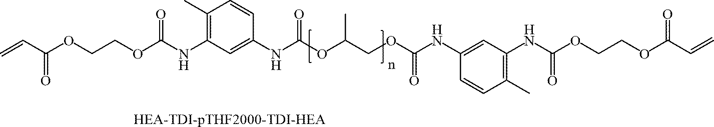

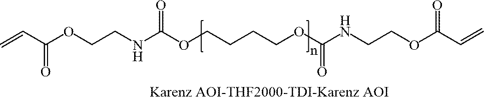

where n is a number in the range from 1 to 16; m and p are each independently numbers in the range of from 0 to 16.

In a seventh embodiment is described a photopolymerizable composition comprising the reactive polyurethane elastomer according to any one of the first through sixth embodiments.

In an eighth embodiment is described the photopolymerizable composition according to the seventh embodiment, further comprising at least one ethylenically unsaturated monomer.

In a ninth embodiment is described the photopolymerizable composition according to the seventh or eighth embodiment, further comprising at least one oligomer differing from the reactive polyurethane elastomer.

In a tenth embodiment is described a method for making the reactive polyurethane elastomer according to any one of the first through sixth embodiments, comprising:
reacting a hydroxyl or amine group terminated prepolymer and a hydroxyl or amine
terminated acrylate derivative with a diisocyanate to form the reactive polyurethane elastomer.

In an eleventh embodiment is described the method according to the tenth embodiment, wherein the diisocyanate is selected from the group consisting of hexamethylene diisocyanate, isophorone diisocyanate, toluene diisocyanate, and methylene diphenyl diisocyanate.

In a twelfth embodiment is described the method according to the tenth or eleventh embodiment, wherein the hydroxyl or amine group terminated prepolymer is a polyether diol with a molecular weight in the range of from 500 to 5,000 g/mol.

In a thirteenth embodiment is described the method according to the twelfth embodiment, wherein the polyether diol has a molecular weight in the range of from 2,000 to 2,900 g/mol.

In a fourteenth embodiment is described a method for producing the reactive polyurethane elastomer according to any one of the first through sixth embodiments, comprising:
reacting a hydroxyl or amine group terminated prepolymer directly with an isocyanate modified acrylate to produce the reactive polyurethane elastomer.

In a fifteenth embodiment is described the method according to the fourteenth embodiment, wherein the hydroxyl or amine group terminated prepolymer is a polyether diol with a molecular weight in the range of from 500 to 5,000 g/mol.

In a sixteenth embodiment is described the method according to the fifteenth embodiment, wherein the polyether diol has a molecular weight in the range of from 2,000 to 2,900 g/mol.

In a seventeenth embodiment is described the method according to the fourteenth, fifteenth, or 16th embodiment, wherein the isocyanate modified acrylate is selected from

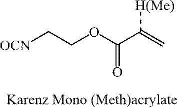

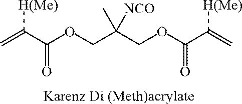

In an eighteenth embodiment is described a method of preparing a three-dimensional article, wherein the method comprises applying successive layers of one or more of the compositions of any one of the seventh to ninth embodiments to fabricate a three-dimensional article, and irradiating the successive layers with UV irradiation.

In a nineteenth embodiment is described the method of the eighteenth embodiment, wherein the applying comprises depositing a first layer of the composition to a substrate and applying a second layer of the composition to the first layer and optionally applying successive layers thereafter.

In a twentieth embodiment is described the method of the eighteenth or nineteenth embodiment, wherein the applying comprises ink jet printing of the composition.

In a twenty-first embodiment is described a three-dimensional article prepared by the method according to any one of the eighteenth through twentieth embodiments.

The present technology, thus generally described, will be understood more readily by reference to the following examples, which are provided by way of illustration and are not intended to be limiting of the present invention.

### EXAMPLES

### Printing and Testing

In each of the below described examples, printing was carried out utilizing Origin MDK 26 printers. The printer is equipped with a heating element and the chamber can reach up to 60° C. and the vat can reach up to 48° C. Typical UV 385 nm light is at 8-9 mW/cm². Exposure times were fixed at 2 seconds. In order to avoid solvent effects, residue resin was removed by napkin wiping. Post cure processing was done with UV 405 nm at 4 mW/cm² in CCW UV cure chamber for 2 minutes for each flat side.

For each of the examples described below, testing for tensile strength was conducted according to ASTM D638 utilizing the type V specimen shape. The tensile rate was 100 mm/min.

Testing for tear resistance was conducted in accordance with ASTM D624. Geometry die C coupons were printed directly from the Origin printer. The measurement as carried on a standard universal testing machine at 20 in/min.

Resilience was tested in accordance with ASTM D2632. A standard test specimen with a thickness of 12.5/6/0.5 mm (0.50/6/0.02 in) was cut from a slab or specifically molded so that the point of plunger impact was a minimum distance of 14 mm (0.55 in) from the edge of the specimen.

Shore A Hardness was tested in accordance with ASTM D2240. A Zwick Roell hardness tester with Shore A attachment was used to conduct the standard measurement. The hardness of 8 different points were measured to achieve the average and standard deviation.

### Mechanical Performance of Commercial and Existing Acrylate Prepolymers

Table 1 shown below gives mechanical performance for commercial and existing acrylate prepolymers used for photo resins. It can be seen that these were not able to achieve a good balance of toughness and resilience.

Laromer® LR UA9072, for example, is a pTHF 1000 based urethane acrylate, with 30% reactive diluent. It is a typical soft touch material with 200% elongation at break, however, the material is typically low in resilience with only 22.5% rebounding performance (Table 3.1). For an application that requires high resilience, such as shoe sole or other harsh mechanical elastomer application, this material will not be adequate.

TABLE 1

Mechanical performance of Commercial and existing acrylate prepolymers

| Sample | Resilience (%) | Hardiness (Shore A) | Error | Tensile Strength (MPa) | Error | Elongation at Break (%) | Error | Tear Resistance (N/mm) | Error |
|---|---|---|---|---|---|---|---|---|---|
| LR UA 9072 w1% TPO | 22.5 | 79.1 | 0.356 | 10.88 | 1.09 | 207.06 | 16.81 | 41.39 | 4.72 |
| LR UA 9089 w1% TPO | 33.5 | 91.8 | 0.622 | 34.72 | 3.18 | 29.95 | 3.04 | 115.83 | 15.23 |
| LR UA 9047 w1% TPO | 66.5 | 95.7 | 0.265 | 30.35 | 4.75 | 2.63 | 0.34 | 25.7 | 12.5 |
| SR610 w1% TPO | 82.5 | 87 | 0.289 | 1.66 | 0.77 | 23.7 | 12.84 | 4.06 | 3.9 |
| SR420 w1% TPO | 46.75 | 90.8 | 0.585 | 21.96 | 5.79 | 1.42 | 0.32 | | |
| UA 19T w1% TPO | 56.5 | 95.5 | 0.189 | 29.39 | 1.25 | 13.2 | 4.02 | 73.37 | 9.05 |

In the above table, as well as throughout the remaining examples, “TPO” is diphenyl (2,4,6-trimethylbenzoyl)phosphine oxide. It can be seen in the above presented results that those prepolymers which obtained a relatively high resilience also had a significant reduction in toughness and/or strength, while those in which there was a higher degree of toughness/strength did not have the resilience that would be required by certain applications such as, for example, shoe soles.

### Oligomer Synthesis According to the First Synthesis Route

Oligomer synthesis was performed under anhydrous conditions in an oven dried reaction flask that was equipped with an overhead mechanical stirrer, temperature probe, condenser, and an air inlet tube that, again, reached below the liquid level of the starting reaction components. The isocyanate was added to the flask at room temperature and then heated up to 50° C. before the desired polyol was gradually added at a rate to maintain the exotherm temperature under 80° C. After the addition of polyol, any short-chain diols, if present in the formulation, were also added and the reaction mixture was then allowed to stir at 80° C. for 2 h. The external heating was then stopped and the reaction mixture was allowed to stir until the reaction temperature naturally lowered to 60° C. or room temperature, if left overnight. A %NCO determination was then performed by automatic titration against dibutylamine in a solution of 1,2,4-trichlorobenzene as described in the Journal of Cellular Plastics, J. Cellular Plastics 27 (1991) 459. A stoichiometric amount of acrylate was then added to consume all of the remaining NCO groups and the reaction temperature was increased to 70° C. in order to facilitate the disappearance of the NCO groups, which was monitored by infrared (IR) spectroscopy until no evidence of the NCO peak existed at approximately 2275 - 2250 cm⁻¹. Most of the oligomer samples made via this modified method proved to be stable for over 6 months by evidence of no doubling in viscosity during this timeframe, however some unexplained gellation was observed in experimental batches containing commercially available Converge polyols produced by Aramco Chemicals, as well as novel polycaprolactam-polybutadiene polyols produced internally. Table 2 summarizes several oligomers synthesized in this manner.

TABLE 2

Oligomers synthesized using synthesis route one

| Sample Name | ISO | Monol | Polyol | Mw | Mn | PD | Residual ISO (GC, wt%) |
|---|---|---|---|---|---|---|---|
| 35623×03 | TDI Type 1 | HEA | Pluracol P2010 | 3220 | 615 | 5.2 | 0.002 |
| 35623×05 | TDI Type 1 | HEA | pTHF 2000 | 5800 | 680 | 8.5 | 0.002 |
| 35623×07 | TDI Type 1 | HEA | Pluracol P1010 | 2600 | 625 | 4.2 | 0.002 |
| 35623×09 | TDI Type 1 | HEA | pTHF 1000 | 4170 | 640 | 6.5 | 0.002 |
| 35623×19 | TDI Type 1 | HEA | pTHF 2000 | 7540 | 2120 | 3.6 | 0.02 |
| 35623×21 | TDI Type 1 | HEA | Pluracol P1010 | 3750 | 2280 | 1.6 | 0.02 |
| 35623×23 | TDI Type 1 | HEA | Pluracol P2010 | 4320 | 1930 | 2.2 | 0.02 |

^{∗}Solidified

In further oligomer synthesis according to the first synthesis route, a zinc neodecanoate catalyst and antioxidants were employed. In this alternative version of the first synthesis route, all of the reaction components including the zinc neodecanoate catalyst, antioxidants, diisocyanate, polyol, and (meth)acrylate were added at the same time at the start of the reaction. The reactions were still monitored for complete consumption of the isocyanate and confirmed by infrared spectroscopy. There were, however, instances when the reaction was further forced to completion by the addition of methanol when the reaction rate still seemed unreasonably long. Dried air was also bubbled continuously into the reaction mixture under the liquid level to help with the overall stability of the product mixture and activity of the antioxidants, as identified as a need in the initial modified syntheses. Table 3 summarizes the TDI, IPDI, and HDI-based oligomers synthesized in this alternative version of the first synthesis route.

TABLE 3

Oligomers synthesized including zinc neodecanoate and MEHQ/PTZ/BHT inhibitors

| Sample Name | ISO | Monol | Polyol | Mw | Mn | PD | Residual ISO (GC, wt%) |
|---|---|---|---|---|---|---|---|
| 35623×27 | TDI Type 1 | HEA | Lupraphen 6601/2 | 7770 | 2160 | 3.6 | 0.02 |
| 35623×29 | IPDI | HEA | Kuraray C-2050R | 13400 | 3050 | 4.4 | 0.07 |
| 35541×45 | TDI Type 1 | HEA | pTHF 2900 | 4880 | 2230 | 2.2 | 1.85 |
| 35623×31 | IPDI | HEA | pTHF250 | 2280 | 1230 | 1.9 | 0.07 |
| 35623×33 | IPDI | HEA | Emerox 14801 | 94000 | 2650 | 35.5 | 0.07 |
| 35623×35 | IPDI | HEA | Emerox 14550 | 10800 | 2710 | 4.0 | 0.07 |
| 35623×37 | IPDI | HEA | Emerox 14725 | 7090 | 1640 | 4.3 | 0.07 |
| 35623×39 | IPDI | HEA | Emerox 14733 | 9690 | 1690 | 5.7 | 0.07 |
| 35623×41 | IPDI | HEA | pTHF 2900 | 18500 | 4210 | 4.4 | 0.07 |
| 35541×48 | TDI Type 1 | HEA | pTHF 2900 | 9710 | 2560 | 3.8 | 0.02 |
| 35541×49 Left | TDI Type 1 | HEA | Lupraphen 6601/2 | 7230 | 2130 | 3.4 | 0.02 |
| 35541×49 Right | TDI Type 1 | HEA | Lupraphen 6601/2 | 7550 | 2320 | 3.3 | 0.02 |
| 35541×62-228 | TDI Type 1 | HEA | pTHF 2000 | 10200 | 2270 | 4.5 | 0.02 |
| 35541×62-230 | TDI Type 1 | HEA | pTHF 2000 | 10300 | 2270 | 4.5 | 0.02 |
| 35541×66 | HDI | HEA | pTHF 2000 | 23400 | 4400 | 5.3 | 0.02 |
| 35541×68 | HDI | HEA | pTHF 1000 | 7750 | 2490 | 3.1 | 0.02 |
| 35541×70 | HDI | HEA | pTHF 2900 | 23900 | 4890 | 4.9 | 0.02 |
| 35541×76 | IPDI | HEA | pTHF2000 | 16300 | 3910 | 4.2 | 0.07 |
| 35541×82 | IPDI | HEA | pTHF 1000 | 13600 | 2620 | 5.2 | 0.07 |
| 35541×92 | IPDI | HEA | pTHF 2900 | 33600 | 5230 | 6.4 | 0.07 |

### Synthesis by the Second Synthesis Route

As discussed in more detail above, it is possible to obtain the instantly described reactive polyurethane elastomers through reaction of an amine or hydroxyl terminated prepolymer with isocyanates which have been modified by acrylate. These modified compounds are shown below:

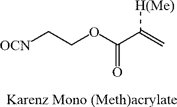

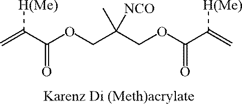

Extension of these compounds was performed with PolyTHF 2000 to compare the relative structure-property relationships of these urethane acrylates in the photopolymer formulation with the oligomers formed above. Table 4 lists the analytical properties of the oligomers synthesized using these modified isocyanates by way of the second synthesis route.

TABLE 4

Oligomers synthesized using non-traditional commercially available isocyanates

| Sample Name | ISO | Polyol | Mw | Mn | PD | Residual ISO (GC, wt%) |
|---|---|---|---|---|---|---|
| 35541×94 | Karenz-AOI™ | pTHF2000 | 6800 | 3070 | 2.2 | 0.02 |
| 35541×96 | Karenz-MOI EG™ | pTHF2000 | 8450 | 3720 | 2.3 | 0.02 |
| 35541×98 | Karenz-BEI™ | pTHF2000 | 6970 | 3180 | 2.2 | 0.02 |
| 35541×100 | Karenz-MOI™ | pTHF2000 | 6700 | 2850 | 2.4 | 0.02 |

### Influence of Chain Length

By varying the chain lengths of polyTHF (i.e. 1000, 2000 and 2900 g/mol), along with different diisocyanates (i.e. TDI, IPDI and HDI), followed by capping all of the NCO functional groups with 2-hydroxylethyl acrylate (HEA) for acrylate functionalization, several urethane acrylate oligomers were synthesized. The molecular weights of these oligomers were tuned by changes in the relative ISO-polyol stoichiometry during the synthesis and by using polyols with higher molecular weight. When the urethane diacrylate has a higher molecular weight, the final cured 3D-printed sample has less crosslinking density, which improves the resilience and tensile strength. As shown in Table 5, the TDI-derived urethane acrylate series has increased resilience from 25% to 47% when the higher molecular weight polyol was used. The glass transition temperatures (Tg) of the TDI series also decreased dramatically from 1 to -62° C. when the molecular weight of polyTHF building block increased from 1000 to 2900 g/mol.

TABLE 5

Mechanical results for varying isocyanate and polyols in HEA capped UAs

| HEA-ISO-Polyol-ISO-HEA | Mw | Mn | PD | Resid ual ISO (GC, wt%) | Resi dual HEA (GC, wt% | Resi lien ce | Tg(° C, DMA) | Hard ness (Shor eA) | Err or | Tensile Strength (MP a) | Err or | Elongation Break (%) | Error | Tear Resistance (N/m m) | Error |
|---|---|---|---|---|---|---|---|---|---|---|---|---|---|---|---|
| HEA-TDI-pTHF1000-TDI-HEA | 4170 | 640 | 6.5 | 0.002 | | 24.7 | 1.1 | 78.7 | 0.1 | 3.9 | 0.4 | 56.8 | 19.0 | 17.3 | 6.5 |
| HEA-TDI-pTHF2000-TDI-HEA | 10200 | 2270 | 4.5 | 0.020 | 7.5 | 47.1 | -50.0 | 83.1 | 0.3 | 7.6 | 1.3 | 56.8 | 11.3 | 21.1 | 3.8 |
| HEA-TDI-pTHF2900-TDI-HEA | 9710 | 2560 | 3.8 | 0.020 | 5.9 | 44.7 | -62.0 | 82.6 | 0.3 | 3.8 | 0.5 | 36.7 | 8.6 | 22.2 | 2.0 |
| HEA-HDI-pTHF1000-HDI-HEA | 7750 | 2490 | 3.1 | 0.020 | 7.1 | 44.3 | -36.9 | 70.0 | 0.9 | 2.5 | 0.2 | 59.9 | 8.8 | 4.8 | 1.5 |
| HEA-HDI-pTHF2000-HDI-HEA | 23400 | 4400 | 5.3 | 0.020 | 4.1 | 70.0 | -58.4 | 67.7 | 0.3 | 2.3 | 0.4 | 49.4 | 8.7 | 6.5 | 1.3 |
| HEA-HDI-pTHF2900-HDI-HEA | 23900 | 4890 | 4.9 | 0.020 | 4.0 | 64.3 | -50.7 | 63.9 | 0.4 | 2.6 | 0.4 | 92.1 | 18.2 | 12.3 | 2.7 |
| HEA-IPDI-pTHF1000-IPDI-HEA | 13600 | 2620 | 5.2 | 0.070 | 8.6 | 27.3 | 20.6 | 80.6 | 0.3 | 5.8 | 3.5 | 65.1 | 24.7 | 15.6 | 2.2 |
| HEA-IPDI-pTHF2000 IPDI-HEA | 16300 | 3910 | 4.2 | 0.070 | 5.2 | 50.0 | -51.3 | 69.4 | 0.8 | 3.3 | 0.3 | 66.2 | 5.9 | 10.4 | 0.6 |
| HEA-IPDI-pTHF2900-IPDI-HEA | 33600 | 5230 | 6.4 | 0.070 | 3.7 | 63.0 | -59.1 | 68.4 | 0.3 | 3.2 | 1.6 | 89.4 | 30.4 | 11.8 | 2.6 |

The HDI-derived urethane acrylate series had the highest jump in resilience from 44% to 70%. The elongation at break of the HDI series increased to 92% with the longer pTHF 2900 polyol chain. Similarly, the IPDI-derived urethane acrylate series had an elongation of 89% with pTHF 2900. In addition to the choice of isocyanate and polyol, the amount of residual HEA may also contribute to the mechanical properties of the final 3D printed part. Some disorder of the mechanical performance may be caused by the presence of unreacted HEA monomer, which ranged from 4% to 8% in all of the oligomers summarized in Table 3.9. Both the HDI/pTHF 2900 and IPDI/pTHF 2900 oligomer samples are standouts among all of the ISO/polyTHF batches with the varied isocyanate component and polyTHF molecular weight.

### Formulation

Formulations were created in which the above tested oligomers were further tested in a 50:50 formulation with Mitsubishi UV3500BA. The results are presented in Table 6 below.

TABLE 6

Mechanical results for 50:50 Formulations with Mitsubishi UV3500BA

| Oligomer and 50:50 Formulation | Resilience (%) | Hardness (Shore A) | Error | Tensile Strength (MPa) | Error | Elongation (%) | Error | Tear Resistance (N/mm) | Error |
|---|---|---|---|---|---|---|---|---|---|
| HEA-TDI-pTHF2000-TDI-HEA | 47.1 | 83.1 | 0.3 | 7.6 | 1.3 | 56.8 | 11.3 | 21.1 | 3.8 |
| HEA-TDI-pTHF2000-TDI-HEA/UV3500BA | 34.4 | 81.0 | 0.9 | 14.1 | 3.9 | 145.2 | 29.4 | 21.0 | 2.2 |
| HEA-TDI-pTHF2900-TDI-HEA | 44.7 | 82.6 | 0.3 | 3.8 | 0.5 | 36.7 | 8.6 | 22.2 | 2.0 |
| HEA-TDI-pTHF2900-TDI-HEA/UV3500BA | 36.4 | 83.9 | 0.4 | 15.6 | 3.2 | 107.1 | 17.1 | 35.2 | 6.9 |
| HEA-HDI-pTHF1000-HDI-HEA | 44.3 | 70.0 | 0.9 | 2.5 | 0.2 | 59.9 | 8.8 | 4.8 | 1.5 |
| HEA-HDI-pTHF1000-HDI-HEA/UV3500BA | 16.0 | 66.6 | 0.2 | 4.2 | 0.6 | 80.1 | 6.9 | 9.4 | 3.4 |
| HEA-HDI-pTHF2000-HDI-HEA | 70.0 | 67.7 | 0.3 | 2.3 | 0.4 | 49.4 | 8.7 | 6.5 | 1.3 |
| HEA-HDI-pTHF2000-HDI-HEA/UV3500BA | 38.3 | 68.9 | 0.2 | 5.3 | 1.4 | 127.3 | 27.1 | 18.3 | 4.2 |
| HEA-HDI-pTHF2900-HDI-HEA | 64.3 | 63.9 | 0.4 | 2.6 | 0.4 | 92.1 | 18.2 | 12.3 | 2.7 |
| HEA-HDI-pTHF2900-HDI-HEA/UV3500BA | 34.7 | 67.5 | 0.2 | 8.1 | 2.6 | 190.1 | 36.5 | 18.2 | 3.0 |
| HEA-IPDI-pTHF1000-IPDI-HEA | 27.3 | 80.6 | 0.3 | 5.8 | 3.5 | 65.1 | 24.7 | 15.6 | 2.2 |
| HEA-IPDI-pTHF1000-IPDI-HEA/UV3500BA | 21.7 | 81.4 | 0.1 | 11.3 | 1.8 | 102.0 | 12.8 | 29.3 | 4.3 |
| HEA-IPDI-pTHF2000-IPDI-HEA | 50.0 | 69.4 | 0.8 | 3.3 | 0.3 | 66.2 | 5.9 | 10.4 | 0.6 |
| HEA-IPDI-pTHF2000-IPDI-HEA/UV3500BA | 29.7 | 74.5 | 0.3 | 10.0 | 3.7 | 141.9 | 36.0 | 23.6 | 2.1 |
| HEA-IPDI-pTHF2900-IPDI-HEA | 63.0 | 68.4 | 0.3 | 3.2 | 1.6 | 89.4 | 30.4 | 11.8 | 2.6 |
| HEA-IPDI-pTHF2900-IPDI-HEA/UV3500BA | 46.3 | 75.0 | 0.7 | 13.8 | 3.3 | 206.8 | 37.2 | 27.2 | 4.4 |

### Inclusion of One or More Ethylenically Unsaturated Monomers

Ethylenically unsaturated monomers can be used to further boost mechanical performance. Using only 1 to 10 wt% can effectively fine tune the properties. For example, acrylate morpholine (ACMO) is a reactive diluent usually used in the formulation of tough material. The leading experimental urethane acrylates based on HDI and IPDI isocyanates and pTHF2900 were formulated with UV3500Ba and ACMO and compared with the Carbon 3D EPU41 benchmark. The mechanical data are listed in the Table 7.

TABLE 7

Effect of reactive diluent on leading HDI and IPDI formulations with UV3500BA

| Formulation | Resilience (%) | Hard ness (Shore A) | Error | Tensile Strength (MPa) | Error | Elongation at Break (%) | Error | Tear Resistance (N/mm) | Error |
|---|---|---|---|---|---|---|---|---|---|
| (BASF X1) HEA-HDI-pTHF2900-HDI-HEA/UV3500BA | 34.7 | 67.5 | 0.2 | 8.1 | 2.6 | 190.1 | 36.5 | 18.2 | 3.0 |
| (BASF X1+) HEA-HDI-pTHF2900-HDI-HEA/UV3500BA/10% ACMO | 44.5 | 80.0 | 1.3 | 17.8 | 1.7 | 218.4 | 15.5 | 37.8 | 3.8 |
| (BASF X2) HEA-IPDI-pTHF2900-IPDI-HEA/UV3500BA | 46.3 | 75.0 | 0.7 | 13.8 | 3.3 | 206.8 | 37.2 | 27.2 | 4.4 |
| (BASF X2+) HEA-IPDI-pTHF2900-IPDI-HEA/UV3500BA /10% ACMO | 42.5 | 85.0 | 0.5 | 19.3 | 4.3 | 191.3 | 38.1 | 48.6 | 4.3 |
| HEA-IPDI-pTHF2900-IPDI-HEA/ UV3500BA/5% DPGDA | 41.5 | 80.7 | 0.9 | 20.1 | 1.6 | 220.2 | 12.9 | 35.6 | 5.5 |
| Carbon 3D EPU40 | 20.0 | 73.0 | n.a. | 62 | n.a. | 244.3 | n.a. | 23.0 | n.a. |
| Carbon 3D EPU41 | 25.0 | 70.5 | n.a. | 9.7 | n.a. | 158.4 | n.a. | 20.0 | n.a. |

The presence of 10 wt% ACMO increased the resilience of the HEA-HDI-pTHF2900-HDI-HEA / UV3500BA formulation from 35 to 45%. Similarly, the HEA-IPDI-pTHF2900-IPDI-HEA / UV3500BA formulation was on a similar level, albeit the resilience decreased slighlty from 46.3 to 42.5%. This phenomenon is related to the intrinsic resilience performance of ACMO. In comparison to the Carbon 3D EPU series products between 20-25%, BASF elastic materials have surpassed the overall mechanical performance. The hardness increased from 13 to 18% due to the reactive diluent. Tensile strength has been improved from 8.1 to 17.8 MPa with 10 wt% of ACMO. The tensile strength has been increased to 19.3% which is far beyond the performance of Carbon 3D EPU 40 (6.2 MPa) and EPU 41 (9.7 MPa) products.

Table 8 below gives a detailed comparison of the physical and mechanical properties observed for the X1 and X2 formulations shown above in Table 7 compared to Carbon EPU commercial benchmark products.

TABLE 8

Quantitative comparison of BASF experimental formulations with Carbon EPUs

| Entry | Resilience (%) | Hardness (Shore A) | Error | Tensile Strength (Mpa) | Error | Elongation at Break (%) | Error | Tear Resistance (N/mm) | Error |
|---|---|---|---|---|---|---|---|---|---|
| BASF X1 | 34.7 | 67.5 | 0.2 | 8.1 | 2.6 | 190.1 | 36.5 | 18.2 | 3.0 |
| BASF X1+ | 44.5 | 80.0 | 1.3 | 17.8 | 1.7 | 218.4 | 15.5 | 37.8 | 3.8 |
| BASF X2 | 46.3 | 75.0 | 0.7 | 13.8 | 3.3 | 206.8 | 37.2 | 27.2 | 4.4 |
| BASF X2+ | 42.5 | 85.0 | 0.5 | 19.3 | 4.3 | 191.3 | 38.1 | 48.6 | 4.3 |
| Carbon EPU40 | 20.0 | 73.0 | n.a. | 6.2 | n.a. | 244.3 | n.a. | 23.0 | n.a. |
| Carbon EPU41 | 25.0 | 70.5 | n.a. | 9.7 | n.a. | 158.4 | n.a. | 20.0 | n.a. |

In the below described example, HEA-HDI-PolyTHF-HDI-HEA was made utilizing a synthesis scheme in which an isocyanate modified acrylate was reacted with a polyether.

Preferred embodiments of this invention are described herein, including the best mode known to the inventors for carrying out the invention. It will be appreciated that the invention is not restricted to the details described above with reference to the preferred embodiments but that numerous modifications and variations can be made without departing from the spirit and scope of the invention as defined by the following claims.

1-21. (canceled)

22. A reactive polyurethane elastomer according to formula (I): 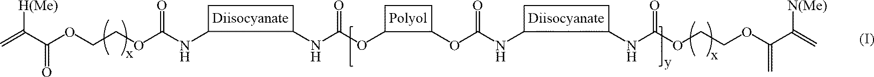
wherein H(Me) indicates either a hydrogen or methyl group,
each x independently is a number in the range of from 1 to 11,
y is a number in the range of from 1 to 20,
Diisocyanate is selected from the group consisting of TDI, HDI, IPDI, and isocyanate-functional acrylate;
Polyol is a polyether or polyerster polyol.

23. The reactive polyurethane elastomer according to claim 22, wherein the diisocyanate is selected from the group consisting of hexamethylene diisocyanate, isophorone diisocyanate, toluene diisocyanate, and methylene diphenyl diisocyanate.

24. The reactive polyurethane elastomer according to claim 23, wherein the diisocyanate is hexamethylene diisocyanate or isophorone diisocyanate.

25. The reactive polyurethane elastomer according to claim 22, wherein the polyol is a polyether diol with a molecular weight in the range of from 500 to 5,000.

26. The reactive polyurethane elastomer according to claim 25, wherein the polyether diol has a molecular weight in the range of 2,000 to 2,900.

27. The reactive polyurethane elastomer according to claim 22, wherein the reactive polyurethane elastomer is selected from the group consisting of 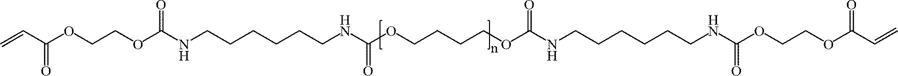
HEA-HDI-pTHF-HDI-HEA 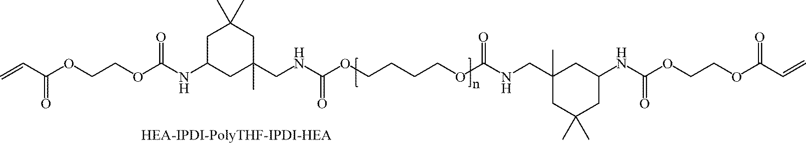 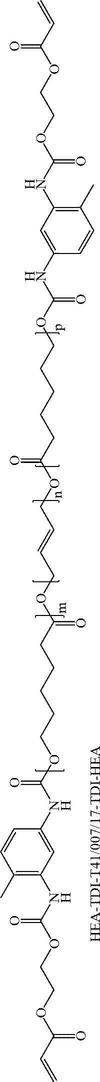 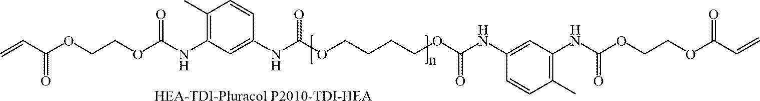 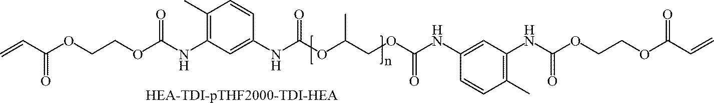 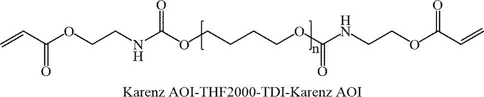
where n is a number in the range from 1 to 16; m and p are each independently numbers in the range of from 0 to 16.

28. A photopolymerizable composition comprising the reactive polyurethane elastomer according to claim 22.

29. The photopolymerizable composition according to claim 28, further comprising at least one ethylenically unsaturated monomer.

30. The photopolymerizable composition according to claim 28, further comprising at least one oligomer differing from the reactive polyurethane elastomer.

31. A method for making the reactive polyurethane elastomer according to claim 22, comprising:
reacting a hydroxyl or amine group terminated prepolymer and a hydroxyl or amine terminated acrylate derivative with a diisocyanate to form the reactive polyurethane elastomer.

32. The method according to claim 31, wherein the diisocyanate is selected from the group consisting of hexamethylene diisocyanate, isophorone diisocyanate, toluene diisocyanate, and methylene diphenyl diisocyanate.

33. The method according to claim 31, wherein the hydroxyl or amine group terminated prepolymer is a polyether diol with a molecular weight in the range of from 500 to 5,000 g/mol.

34. The method according to claim 33, wherein the polyether diol has a molecular weight in the range of from 2,000 to 2,900 g/mol.

35. A method for producing the reactive polyurethane elastomer according to claim 22, comprising:
reacting a hydroxyl or amine group terminated prepolymer directly with an isocyanate modified acrylate to produce the reactive polyurethane elastomer.

36. The method according to claim 35, wherein the hydroxyl or amine group terminated prepolymer is a polyether diol with a molecular weight in the range of from 500 to 5,000 g/mol.

37. The method according to claim 36, wherein the polyether diol has a molecular weight in the range of from 2,000 to 2,900 g/mol.

38. The method according to claim 35, wherein the isocyanate modified acrylate is selected from 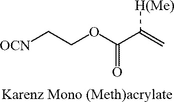 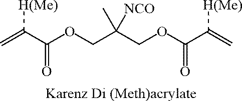
.

39. A method of preparing a three-dimensional article, wherein the method comprises applying successive layers of one or more of the composition of claim 28 to fabricate a three-dimensional article, and irradiating the successive layers with UV irradiation.

40. The method of claim 39, wherein the applying comprises depositing a first layer of the composition to a substrate and applying a second layer of the composition to the first layer and optionally applying successive layers thereafter.

41. The method of claim 39, wherein the applying comprises ink jet printing of the composition.

42. A three-dimensional article prepared by the method according to claim 39.
